(19) United States
(12) Patent Application Publication
(10) Pub. No.: US 2026/0309224 A1
(43) Pub. Date: Oct. 8, 2026

(54) METHOD FOR OPERATING A HYDRAULIC DEVICE

(71) Applicant: Schaeffler Technologies AG & Co. KG, Herzogenaurach (DE)

(72) Inventors: Yunfan Wei, Bühl (DE); Marco Grethel, Bühlertal (DE)

(73) Assignee: Schaeffler Technologies AG & Co. KG, Herzogenaurach (DE)

(21) Appl. No.: 18/864,124

(22) PCT Filed: Feb. 15, 2023
(86) PCT No.: PCT/DE2023/100124

§ 371 Date: Nov. 8, 2024

(30) Foreign Application Priority Data
May 11, 2022 (DE) 10 2022 111 739.1

(51) Int. Cl. F15B 13/04

(52) U.S. Cl. CPC F15B 13/0401

(57) ABSTRACT

A method for operating a hydraulic device having a fluid pump device which provides a fluid volume flow on the basis of at least one pump parameter, a first fluid branch which is connected to the fluid pump device and has a system pressure, a second fluid branch which is connected to the fluid pump device, a system valve which is effectively arranged between the first and second fluid branch in order to adjust the system pressure, and an additional valve which is effectively arranged between the fluid pump device and the second fluid branch. The additional valve is switchable by means of a switching process in order to change the valve state, wherein according to the valve state, the additional valve increases the fluid volume flow exiting the fluid pump device in the direction of the second fluid branch as a first volume fluid flow conducted via the first fluid branch, thereby carrying out a feed process from the first fluid branch. The pump parameter of the fluid pump device is adapted during the switching process in order to limit a fluctuation of a fluid parameter of the first fluid volume flow.

### CROSS-REFERENCE TO RELATED APPLICATIONS

This application is the U.S. National Phase of PCT Appln. No. PCT/DE2023/100124 filed Feb. 15, 2023, which claims priority to DE 10 2022 111 739.1 filed May 11, 2022, the entire disclosures of which are incorporated by reference herein.

### TECHNICAL FIELD

The disclosure relates to a method for operating a hydraulic device.

### BACKGROUND

DE 10 2020 119 161 A1 describes a hydraulic device having a first pump that provides a fluid volume flow for cooling and/or lubrication at an outlet and having a second pump that provides a fluid pressure for at least one hydraulic consumer at an outlet. An additional active valve connected upstream of the cooling and/or lubrication is connected in the hydraulic system to a system pressure valve and at least one hydraulic consumer to be boosted in such a way that the outlets of the two pumps are connected in a boost state to the hydraulic consumer to be boosted via a boost line.

### SUMMARY

The object of the present disclosure is to reduce a fluid parameter fluctuation. The hydraulic device is to be operated in a more considerate manner. Consumers connected to the hydraulic device are to be operated more reliably.

At least one of these objects is achieved by a method for operating a hydraulic device having the features described herein. This allows the first fluid volume flow to be adjusted in a more uniform manner and with reduced fluid parameter fluctuations. The components that receive the first fluid volume flow can be better protected against dynamic loads.

The hydraulic device can be arranged in a vehicle. The vehicle can be a hybrid or electric vehicle. The hydraulic device can have a hydraulic fluid, for example a hydraulic oil. The fluid volume flow and system pressure can be those of a hydraulic fluid.

The hydraulic device can be connected to at least one consumer, for example a clutch, a parking lock device, a brake, an electric motor or a transmission. The hydraulic device can effect an actuation, cooling and/or lubrication of the consumer.

The first fluid branch can effect an actuation of the consumer. The second fluid branch can effect a cooling and/or lubrication of the consumer or a further consumer. The system pressure in the first fluid branch can regularly be greater than a fluid pressure in the second fluid branch. The fluid volume flow in the second fluid branch can regularly be greater than a fluid volume flow in the first fluid branch.

The fluid pump device can have a reversing pump. The fluid pump device can have a tandem pump or double pump. The fluid pump device can have a first fluid pump connected to the first fluid branch and a second fluid pump connected to the second fluid branch. The first fluid pump can be designed to provide a fluid pressure. The second fluid pump can be designed to provide a fluid volume flow. The fluid pump device, preferably the first and/or second fluid pump, can be operated by an electric motor. The first and second fluid pumps can be operated by a common electric motor.

The fluid volume flow of the fluid pump device supplying the first fluid volume flow in the direction of the second fluid branch in the second valve state of the additional valve is preferably a fluid volume flow of the second fluid pump.

The system valve can be switchable depending on the system pressure. The system valve can be electrically actuated. The system valve can be a 2/2-way valve.

The additional valve can be a 2/2-way valve. The additional valve can be electrically actuated.

The fluid parameter fluctuation can be a dynamic overshoot when the first fluid volume flow changes from a first fluid volume flow value to a second fluid volume flow value. The overshoot can be a dynamic increase in the first fluid volume flow and/or the system pressure when the first fluid volume flow value is less than the second fluid volume flow value. The overshoot can be a dynamic decrease in the first fluid volume flow and/or the system pressure when the first fluid volume flow value is greater than the second fluid volume flow value.

In the present case, a “supply” is understood to mean an additional superimposed supply of a fluid volume flow.

In an advantageous embodiment of the disclosure, the switching process switches the additional valve between a first valve state and a second valve state. Switching between the first and second valve states can be performed electrically.

In a particular embodiment of the disclosure, it is advantageous if, in the first valve state, the additional valve releases a connection between the fluid pump device and the second fluid branch through which a fluid volume flow passes. This allows the fluid volume flow provided by the fluid pump device to be conducted directly into the second fluid branch.

A preferred embodiment of the disclosure is advantageous in which, in the second valve state, the additional valve blocks a hydraulic connection between the fluid pump device and the second fluid branch. As a result, the fluid volume flow to the second fluid branch can be conducted via the first fluid branch and increased as the first fluid volume flow.

In a particular embodiment of the disclosure, it is advantageous if the pump parameter is initially controlled in an open loop with an open-loop parameter control during the switching process and is adjusted in a closed loop from a first point in time depending on a control variable with a closed-loop parameter control. It is also possible that only an open-loop parameter control or only a closed-loop parameter control is performed during the switching process.

In an advantageous embodiment of the disclosure, a predetermined gradient of the pump parameter is adjusted in the open-loop parameter control. This allows for a targeted decrease or increase of the pump parameter over time to be implemented. The gradient can be adjusted depending on the operating temperature and/or the system pressure. With the open-loop parameter control, one gradient and subsequently at least one further gradient can be predetermined. With the open-loop parameter control, the pump parameter can be increased and/or decreased.

In a preferred embodiment of the disclosure, a maximum value of the pump parameter is limited in the open-loop parameter control. This allows the pump parameter to be limited to a predetermined range of values.

In a preferred advantageous embodiment of the disclosure, the first point in time is an extreme value of the temporal course of the system pressure and/or the first fluid volume flow during the switching process. The extreme value can be a local minimum or maximum in the temporal course of the system pressure and/or the first fluid volume flow. The extreme value can form the transition between a falling and a rising system pressure and/or first fluid volume flow.

In a preferred advantageous embodiment of the disclosure, the pump parameter is a pump speed and/or a pump volume flow of the fluid pump device. This allows the first fluid volume flow to be influenced quickly and immediately.

Further advantages and advantageous embodiments of the disclosure arise from the description of the figures and the drawings.

### BRIEF DESCRIPTION OF THE DRAWINGS

The disclosure is described in detail below with reference to the drawings. In the drawings:

FIG. 1: shows a hydraulic device for carrying out the method in a particular embodiment of the disclosure.

FIG. 2: shows time diagrams when the method is carried out in a particular embodiment of the disclosure.

FIG. 3: shows time diagrams when the method is carried out in a further particular embodiment of the disclosure.

### DETAILED DESCRIPTION

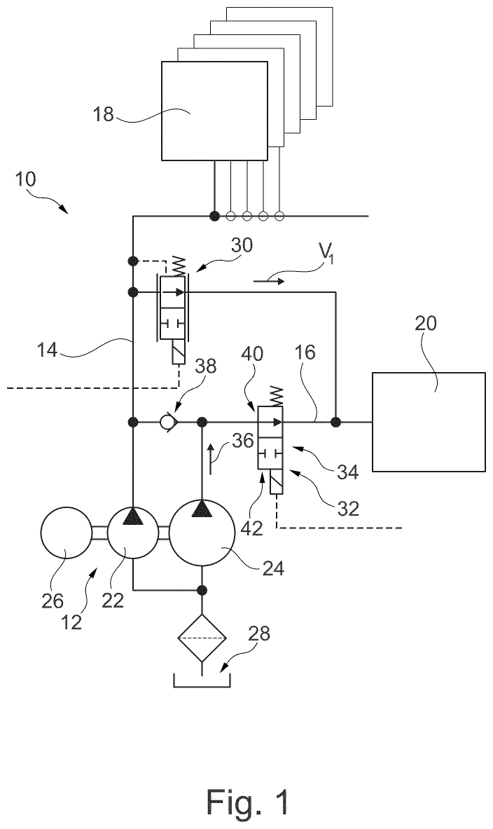

FIG. 1 shows a hydraulic device for carrying out the method in a particular embodiment of the disclosure. The hydraulic device 10 comprises a fluid pump device 12 which provides a fluid volume flow of a hydraulic fluid, in particular a hydraulic oil, depending on at least one pump parameter, for example a pump speed and/or a pump volume flow. A first fluid branch 14, in which a system pressure is present, is connected to the fluid pump device 12 on the one hand and a second fluid branch 16 is connected to the fluid pump device 12 on the other hand. An actuating pressure can be applied to a consumer 18, for example a clutch, via the system pressure of the first fluid branch 14, for example in order to actuate the clutch. The second fluid branch 16 is connected to a further consumer 20, for example an electric motor, and can provide a fluid volume flow for cooling and/or lubrication.

The fluid pump device 12 comprises a first fluid pump 22 and a second fluid pump 24, both of which are driven by an electric motor 26 and which draw the fluid from a fluid reservoir 28. The first fluid pump 22 is connected to the first fluid branch 14 and the second fluid pump 24 is connected to the second fluid branch 16.

A system valve 30 is effectively arranged between the first and second fluid branches 14, 16 in order to adjust the system pressure. The system valve 30 can be designed as a 2/2-way valve. An additional valve 32 is effectively arranged between the second fluid pump 24 and the second fluid branch 16. The additional valve 32 is preferably designed as a 2/2-way valve. The additional valve 32 is switchable by means of a switching process in order to change a valve state 34 and, depending on the valve state 34 of the additional valve 32, a fluid volume flow 36 exiting from the fluid pump device 12 in the direction of the second fluid branch 16 is increased as a first fluid volume flow V₁ conducted via the first fluid branch 14 with supply from the first fluid branch 14. This allows, for example, an increased first fluid volume flow V₁ to be built up, for example in order to fill a clutch connected to the second fluid branch 16 with the fluid.

A check valve 38 is effectively arranged between the first fluid branch 14 on the one hand and the second fluid pump 24 and the additional valve 32 on the other hand and effects a hydraulic passage at a higher fluid pressure on the side of the additional valve 32 and the second fluid pump 24 compared to a system pressure in the first fluid branch 14. On the other hand, the check valve 38 blocks a fluid passage at the same pressure ratio or a reversed pressure ratio between the fluid pressure on the one hand and the system pressure on the other.

During the switching process, the additional valve 32 switches between a first valve state 40 and a second valve state 42. In order to increase the first fluid volume flow V₁, the additional valve 32 switches the second valve state 42, in which it blocks a hydraulic connection between the fluid pump device 12 and the second fluid branch 16. When the second fluid pump 24 is in operation, the fluid volume flow 36 is conducted into the second fluid branch 16 via the check valve 38, the first fluid branch 14 and the system valve 30 as an increased first fluid volume flow V₁ and is present there to the required extent. As a result, the first fluid volume flow V₁ supplied to the second fluid branch 16 can be increased compared to the fluid volume flow 36 that is present when the second fluid pump 24 is directly hydraulically connected to the second fluid branch 16. The first fluid pump 22 can additionally be operated, if required, in order to further increase the first fluid volume flow V₁. This can effect an amplification of the first fluid volume flow V₁.

In the first valve state 40, the second fluid pump 24 is hydraulically connected to the second fluid branch 16 and a fluid volume flow 36 of the second fluid pump 24 is conducted directly into the second fluid branch 16.

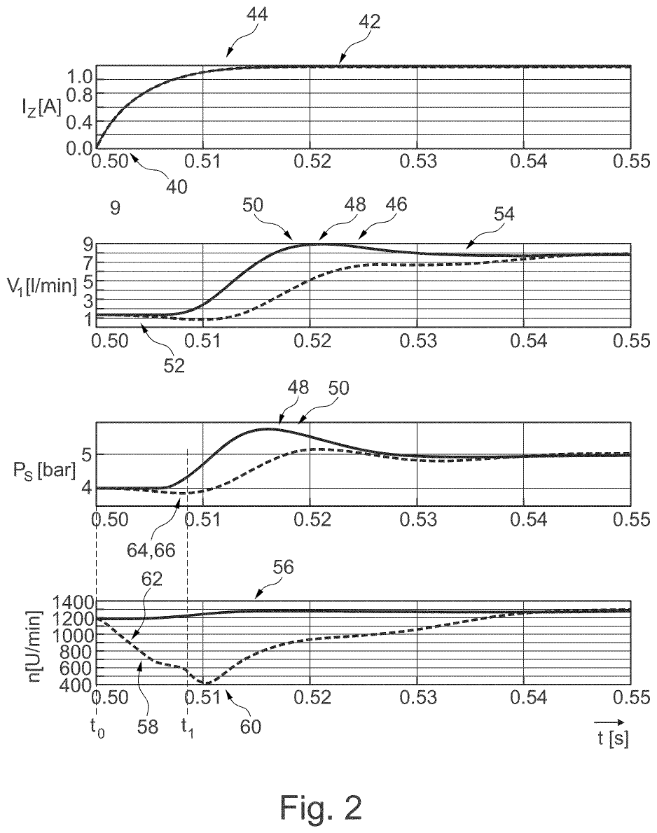

FIG. 2 shows time diagrams when the method is carried out in a particular embodiment of the disclosure. The second valve state 42 with the fluid volume flow delivered by the second fluid pump effects a first fluid volume flow V₁, which is higher than with the first valve state 40. The system pressure pₛ also increases due to the second valve state 42 and the delivered fluid volume flow of the second fluid pump in the first fluid branch, in particular from 4 bar to 5 bar.

During the switching process 44, a fluid parameter fluctuation 46 of the first fluid volume flow V₁ can arise, which occurs as a dynamic increase 48 of the first fluid volume flow V₁ and the system pressure pₛ when the additional valve switches from the first valve state 40 to the second valve state 42 due to a change in the actuating current I_{z} of the additional valve. This dynamic overshoot 50 when the first fluid volume flow V₁ changes from a first fluid volume flow value 52 to a second fluid volume flow value 54 can have a detrimental effect on consumers connected to the second fluid branch and must be decreased.

During the switching process 44, the pump parameter 56 of the fluid pump device, for example the pump speed n and/or the pump volume flow, is adapted to limit the fluid parameter fluctuation 46 of the first fluid volume flow V₁. The time diagrams show a comparison between a switching process 44 in which the pump parameter 56 is adapted, here represented by dashed curves, compared to a lack of adaptation in the switching process 44, here represented by solid curves. The adaptation in the case of the dynamic increase 48 of the first fluid volume flow V₁ occurring here initially comprises an open-loop parameter control 58, in which the pump parameter 56, in this case the pump speed n, is controlled in an open loop, and from a first point in time t₁ comprises a closed-loop parameter control 60, in which the pump parameter 56, in this case the pump speed n, is controlled in a closed loop depending on a control variable.

For this purpose, at the beginning of the switching process 44 at the starting point in time t₀, the pump speed n is decreased with a predetermined gradient 62 of the pump speed n until the closed-loop parameter control 60 is performed at the first point in time t₁, with which the pump speed n or the pump volume flow is adjusted depending on the system pressure pₛ as a control variable. The first point in time t₁ is in particular an extreme value 64 of the temporal course of the system pressure pₛ during the switching process 44, in this case a transition from a falling system pressure pₛ to a rising system pressure pₛ with the extreme value 64 as a local minimum 66 in the temporal course of the system pressure pₛ.

By adapting the pump parameter 56 by means of the open-loop parameter control 58 and subsequent closed-loop parameter control 60, the fluid parameter fluctuation 46, in this case a dynamic overshoot of the first fluid volume flow V₁ and a dynamic overshoot 50 of the system pressure pₛ, is limited.

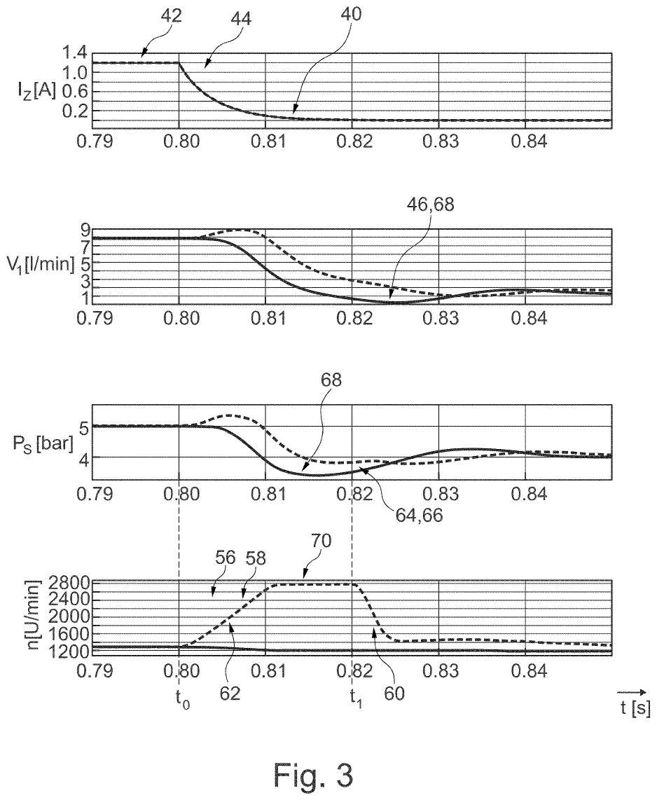

FIG. 3 shows time diagrams when the method is carried out in a further particular embodiment of the disclosure. During the switching process 44 that begins at the starting point in time t₀, the second valve state 42 is changed to the first valve state 40 of the additional valve by switching off the actuating current I_{z} of the additional valve.

As in FIG. 2, the time diagrams illustrate a comparison of an adaptation of the pump parameter 56, here represented by dashed curves, and a lack of adaptation of the pump parameter 56, here represented by solid curves.

In the absence of adaptation of the pump parameter 56, a fluid parameter fluctuation 46 occurs in the first fluid volume flow V₁, in this case as a dynamic decrease 68 of the first fluid volume flow V₁ and as a dynamic decrease 68 of the system pressure pₛ. By adapting the pump parameter 56, in this case increasing the pump speed n by adjusting a predetermined gradient 62 of the pump speed n by means of an open-loop parameter control 58, the fluid parameter fluctuation 46 can be reduced and the dynamic decrease 68 of the system pressure pₛ can also be limited.

The open-loop parameter control 58 is performed up to the first point in time t₁ from which the closed-loop parameter control 60 is performed, with which the pump speed n or a pump volume flow is adjusted depending on the system pressure pₛ as a control variable. The first point in time t₁ is, in this case, an extreme value 64 of the temporal course of the system pressure pₛ during the switching process 44, in this case a transition from a falling system pressure pₛ to a rising system pressure pₛ with the extreme value 64 as a local minimum 66 in the temporal course of the system pressure pₛ.

In the open-loop parameter control 58, a maximum value 70 of the pump parameter 56, in this case the pump speed n, is also limited. This can prevent the fluid pump device from being overloaded.

### List of Reference Signs

10 Hydraulic device
12 Fluid pump device
14 First fluid branch
16 Second fluid branch
18 Consumer
20 Consumer
22 First fluid pump
24 Second fluid pump
26 Electric motor
28 Fluid reservoir
30 System valve
32 Additional valve
34 Valve state
36 Fluid volume flow
38 Check valve
40 First valve state
42 Second valve state
44 Switching process
46 Fluid parameter fluctuation
48 Dynamic increase
50 Dynamic overshoot
52 First fluid volume flow value
54 Second fluid volume flow value
56 Pump parameter
58 Open-loop parameter control
60 Closed-loop parameter control
62 Gradient
64 Extreme value
66 Local minimum
68 Dynamic decrease
70 Maximum value
I_{z} Actuating current
V₁ First fluid volume flow
n Pump speed
pₛ System pressure
t₀ Starting point in time
t₁ First point in time

1. A method for operating a hydraulic device comprising: providing a fluid pump device, which provides a fluid volume flow depending on at least one pump parameter,
providing a first fluid branch which is connected to the fluid pump device on the one hand and has a system pressure,
providing a second fluid branch which is connected to the fluid pump device on the other hand,
providing a system valve which is effectively arranged between the first and second fluid branches in order to adjust the system pressure,
providing an additional valve which is effectively arranged between the fluid pump device and the second fluid branch and which is switchable by means of a switching process in order to change a valve state,
wherein the additional valve increases, depending on the valve state, the fluid volume flow exiting from the fluid pump device in a direction of the second fluid branch as a first fluid volume flow conducted via the first fluid branch with supply from the first fluid branch, and
wherein the pump parameter of the fluid pump device is adapted during the switching process in order to limit a fluid parameter fluctuation of the first fluid volume flow.

2. The method for operating the hydraulic device according to claim 1, wherein the fluid parameter fluctuation is a dynamic overshoot when the first fluid volume flow changes from a first fluid volume flow value to a second fluid volume flow value.

3. The method for operating the hydraulic device according to claim 1, wherein the switching process switches the additional valve between a first valve state and a second valve state.

4. The method for operating the hydraulic device according to claim 3, wherein, in the first valve state, the additional valve releases a connection between the fluid pump device and the second fluid branch through which a fluid volume flow passes.

5. The method for operating the hydraulic device according to claim 3, wherein, in the second valve state, the additional valve blocks a hydraulic connection between the fluid pump device and the second fluid branch.

6. The method for operating the hydraulic device according to claim 1, wherein the pump parameter is initially controlled in an open loop with an open-loop parameter control during the switching process and is adjusted in a closed loop from a first point in time depending on a control variable with a closed-loop parameter control.

7. The method for operating the hydraulic device according to claim 6, wherein a predetermined gradient of the pump parameter is adjusted in the open-loop parameter control.

8. The method for operating the hydraulic device according to claim 6, wherein a maximum value of the pump parameter is limited in the open-loop parameter control.

9. The method for operating the hydraulic device according to claim 6, wherein the first point in time is an extreme value of a temporal course of the system pressure during the switching process.

10. The method for operating the hydraulic device according to claim 1, wherein the pump parameter is a pump speed and/or a pump volume flow of the fluid pump device.
